(19) United States
(12) Patent Application Publication
(10) Pub. No.: US 2005/0034304 A1
(43) Pub. Date: Feb. 17, 2005

(54) Method for producing a housing element of a supply pump provided with a channel housing element for a supply pump and a tool mould for producing a housing element comprising a channel

(76) Inventors: Dirk Becker, Deutschland (DE); Sabine Burhenne, Deutschland (DE); Johannes Deichmann, Alheim-Sterkelshausen (DE); Karsten Meiser, Frielendorf (DE)

Correspondence Address: Mayer Brown Rowe & Maw, 190 South La Salle Street, Chicago, IL, 60603-3441, US

(21) Appl. No.: 10/488,807

(22) PCT Filed: Sep. 6, 2002
(86) PCT No.: PCT/DE02/03309

(30) Foreign Application Priority Data
Sep. 6, 2001 (DE) 101438109

(51) Int. Cl. B23P 15/00

(52) U.S. Cl. 29/888.02

(57) ABSTRACT

A method for manufacturing a fuel feed pump casing part in which two mould parts are brought together to form a flow channel and in which a punch is used to remove a burr that is created in the flow channel by the mould parts when forming the channel.

### BACKGROUND OF THE INVENTION

The invention relates to a method for the manufacture of a casing part, having a channel, of a feed pump, in a tool mould having at least two mould parts, in which method the mould parts are brought into a position in which they rest against one another. The invention relates, furthermore, to a casing part for a feed pump, in particular for a fuel pump designed as a side-channel or peripheral pump, which casing part is configured, for manufacture in a tool mould, as a mould part with at least one central parting plane, with an end face provided for arrangement opposite a rotor of the feed pump, and with a channel led from the end face as far as a second side. The invention relates, moreover, to a tool mould for the manufacture of a casing part, having a channel, of a feed pump.

Casing parts, known from practice, for feed pumps, have an inlet channel or an outlet channel and are often manufactured from plastic in an injection mould. The mould parts of the injection mould have a shell-shaped configuration. One of the mould parts has a die forming the channel.

This has the disadvantage that, after wear, the mould parts no longer rest reliably against one another, so that a burr occurs during manufacture. Such a burr can be eliminated manually only at a very high outlay. Moreover, since the channel is configured so as to narrow toward the end face to be arranged opposite the rotor, the burr occurs at a narrow point of the channel where the flow velocity is particularly high, and said burr produces particularly high resistance to a flow of the feed pump. Particularly with regard to a feed pump used as a fuel pump, the burr may generate gas bubbles in the flow. These gas bubbles occur to an increased extent at high temperatures and lead to a cavitation of the casing part. Even after the manual removal of the burr, an unevenness causing turbulence in the flow remains in the wall of the channel in the region of the parting plane.

The problem on which the invention is based is to design a method of the type initially mentioned, in such a way that it reliably avoids the occurrence of a burr in a region of the channel which is provided for a high flow velocity. Furthermore, a simple-to manufacture casing part of the type initially mentioned is to be provided, in which turbulences of the flow are avoided to the greatest possible extent. Moreover, a tool mould is to be provided which allows as cost-effective a manufacture of the casing part as possible.

### BRIEF DESCRIPTION OF THE INVENTION

The first-mentioned problem is solved, according to the invention, in that, to move the mould parts into the position in which they rest against one another, they are in each case moved into the channel.

As a result, a possible burr occurring between the mould parts is shifted to a point remote from the end face located opposite the rotor. Consequently, by virtue of the invention, the occurrence of a burr is reliably avoided in the region of the channel which is provided for a high flow velocity. Turbulences in the flow of the medium to be fed are therefore kept particularly low.

According to an advantageous development of the invention, a complicated manual re-machining of the casing part can be avoided in a simple way when a burr generated by the mould parts is removed by the punching method.

The second-mentioned problem, to be precise provision of a casing part in which turbulences of the flow are avoided to the greatest possible extent, is solved, according to the invention, in that the parting plane is arranged within the channel.

By virtue of this configuration, a burr generated by the parting plane is at a distance from the end face to be arranged opposite the rotor. Turbulences of the flow flowing into the rotor can thereby be largely avoided. The feed pump provided with the casing part according to the invention therefore has particularly high efficiency.

According to an advantageous development of the invention, the parting plane can be oriented in the channel with respect to the direction of flow in a simple way when the parting plane is arranged so as to be inclined at an intended angle with respect to the axis of the channel. This leads to a further reduction in the turbulences of the flow in the channel.

Often, for the guidance of the flow, the channel is configured so as to bend at an intended angle to the rotor.

In this case, according to another advantageous development of the invention, the casing part according to the invention can be manufactured particularly simply when the parting plane is arranged between a first portion, adjacent to the end face, of the channel and a second portion adjoining the first portion and arranged transversely to the latter. A further advantage of this configuration is that the portions of the channel in each case have an undercut-free configuration, so that the casing part can be removed from the mould axially in a simple way.

According to another advantageous development of the invention, a contribution to a further reduction of the turbulences in the flow is made when the parting plane is spaced apart from a guide lip, adjacent to the end face, for the flow to be fed.

According to another advantageous development of the invention, a lateral deflection of the flow in the channel can be avoided in a simple way when that region of the parting plane which is adjacent to the end face is led parallel to the guide lip.

According to another advantageous development of the invention, with regard to a mechanical re-machining of the guide lip, said re-machining usually being necessary in any case, a contribution to a further reduction of the turbulences in the flow is made when the parting plane is led from the guide lip as far as the opposite side.

The last-mentioned problem, to be precise the provision of a tool mould which allows as cost-effective a manufacture of the casing part as possible, is solved, according to the invention, by means of regions of two mould parts, said regions in each case projecting into the channel and having an undercut-free configuration. By virtue of this configuration, the casing part can be drawn out of the tool mould axially in a simple way. The manufacture of the casing part thereby becomes particularly cost-effective. By virtue of the invention, unevennesses in the channel which are formed by the mould parts in their regions adjacent to one another can be shifted into a region in which the flow within the channel is impaired to a particularly small extent.

### BRIEF DESCRIPTION OF THE DRAWINGS

The invention permits numerous embodiments. To make its basic principle even clearer, one of these is illustrated in the drawing and is described below. In the drawing:

FIG. 1 shows a sectional illustration through a feed pump with a casing part according to the invention,

FIG. 2 shows a greatly enlarged illustration of a part region of the casing part from FIG. 1 during manufacture,

FIG. 3 shows the casing part from FIG. 2 during the removal of a burr.

### DETAILED DESCRIPTION OF THE INVENTION

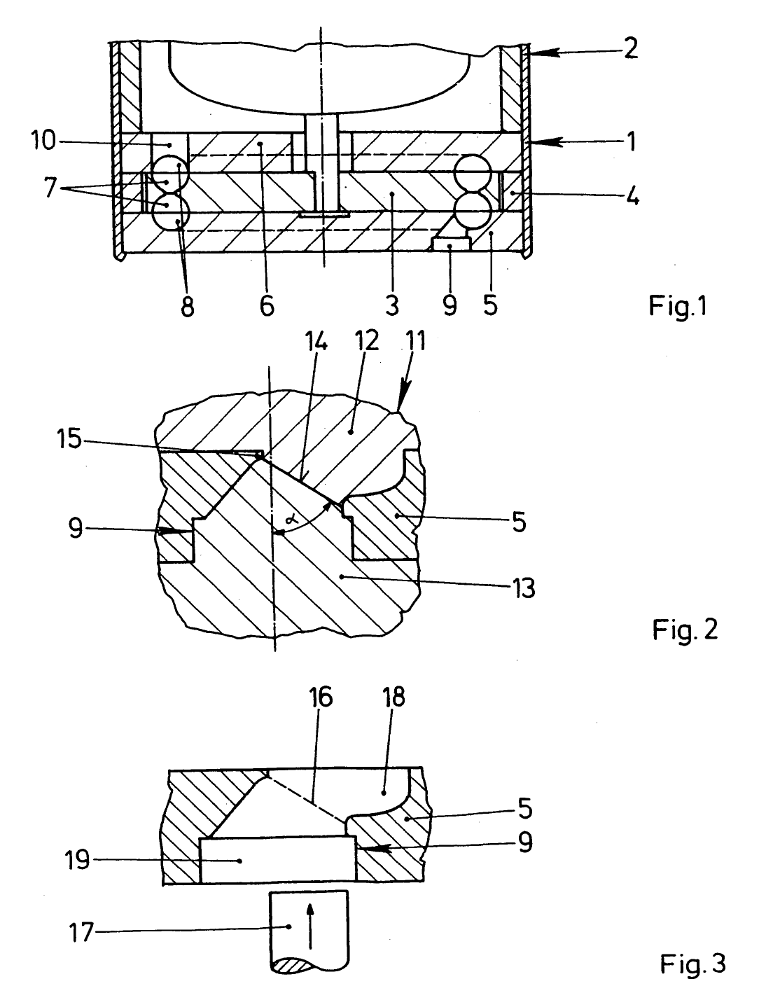

FIG. 1 shows a feed pump 1 according to the invention designed as a side-channel pump. The feed pump 1 may be used, for example, as a fuel pump for feeding fuel in a motor vehicle. The feed pump 1 has a rotor 3 driven by an electric motor 2. Two casing parts 5, 6 held at a distance from one another in the intended position by an annular spacer 4 are located opposite the rotor 3.

Blade chambers 7 are arranged in the rotor 3. The casing parts 5, 6 have part-annular channels 8 located opposite the blade chambers 7. A channel 9, 10 connected to the respective part-annular channel 8 is arranged in each of the casing parts 5, 6. The channel 9 arranged at the free end of the feed pump 1 is designed as an inlet channel, while the channel 10 pointing toward the electric motor 2 is designed as an outlet channel.

FIG. 2 shows a part region of the casing part 5 arranged at the free end of the feed pump 1 from FIG. 1, with the channel 9 designed as an inlet channel, in a greatly enlarged illustration, during manufacture in a tool mould 11. The tool mould 11 has two mould parts 12, 13 in each case projecting with a part region into the channel 9. The tool mould 11 may be, for example, an injection mould. The mould parts 12, 13 rest against one another within the channel 9 in a parting plane arranged so as to be inclined at the angle α and in each case have an undercut-free configuration. The casing part 5 can thereby be removed from the mould by the mould parts 12, 13 being drawn apart axially. The parting plane 14 is led as far as a guide lip 15 of the casing part 5, said guide lip being provided for guiding the medium fed by the feed pump 1.

After the casing part 5 has been removed from the tool mould 11, a burr 16, illustrated in FIG. 3, may occur in the region of the parting plane 14. The burr is located between a first portion 18 located opposite the rotor from FIG. 1 and a second portion 19 arranged transversely to the first portion 18. The burr 16 can be removed by means of a punching tool 17 to be pressed through the channel 9. The punching tool 17 has a cross section corresponding to the projected area of the parting plane 14 on to the end face of the casing part 5.

1. A method for the manufacture of a casing part, having a channel, of a feed pump, in a tool mould having at least two mould parts, in which method the mould parts are brought into a position in which they rest against one another, characterized in that, to move the mould parts into the position in which they rest against one another, they are in each case moved into the channel.

2. The method as claimed in claim 1, characterized in that a burr generated by the mould parts is removed by the punching method.

3. A casing part for a feed pump, in particular for a fuel pump designed as a side-channel or peripheral pump, which casing part is configured, for manufacture in a tool mould, as a mould part with at least one central parting plane, with an end face provided for arrangement opposite a rotor of the feed pump, and with a channel led from the end face as far as a second side, characterized in that the parting plane (14) is arranged within the channel (9).

4. The casing part as claimed in claim 3, characterized in that the parting plane (14) is arranged so as to be inclined at an intended angle (α) with respect to the axis of the channel (9).

5. The casing part as claimed in claim 3 or 4 characterized in that the parting plane (14) is arranged between a first portion (18), adjacent to the end face, of the channel (9) and a second portion (19) adjoining the first portion (18) and arranged transversely to the latter.

6. The casing part as defined in claim 4, characterized in that the parting plane (14) is spaced apart from a guide lip (15), adjacent to the end face, for the flow to be fed.

7. The casing part as defined in claim 6, characterized in that that region of the parting plane (14) which is adjacent to the end face is led parallel to the guide lip (15).

8. The casing part as defined in claim 7, characterized in that the parting plane (14) is led from the guide lip (15) as far as the opposite side.

9. A tool mould for the manufacture of a casing part, having a channel, of a feed pump, characterized by regions of two mould parts (12, 13), said regions in each case projecting into the channel (9) and having an undercut-free configuration.
